(19) United States
(12) Patent Application Publication
(10) Pub. No.: US 2003/0120493 A1
(43) Pub. Date: Jun. 26, 2003

(54) Method and system for updating and customizing recognition vocabulary

(76) Inventor: Sunil K. Gupta, Edison, NJ (US)

Correspondence Address: HARNESS, DICKEY & PIERCE, P.L.C., P.O. BOX 8910, RESTON, VA, 20195, US

(21) Appl. No.: 10/027,580

(22) Filed: Dec. 21, 2001

(51) Int. Cl. G10L 21/00; G10L 11/00

(52) U.S. Cl. 704/270.1

(57) ABSTRACT

The system includes a client device in communication with a server. The client device receives an input speech utterance in a voice dialog via an input device from a user of the system. The client device includes a speech recognition engine that compares the received input speech to stored recognition vocabulary representing a currently active vocabulary. The speech recognition engine recognizes the received utterance, and an application dynamically updates the recognition vocabulary. The dynamic update of the active vocabulary can also be initiated from the server, depending upon the client application being run at the client device. The server generates a result that is sent to the client device via a suitable communication path. The client application also provides the ability to customize voice-activated commands in the recognition vocabulary related to common client device functions, by using a speaker-training feature of the speech recognition engine.

### BACKGROUND OF THE INVENTION

1. Field of the Invention

The present invention relates generally to the field of speech recognition and, more particularly, to a method and a system for updating and customizing recognition vocabulary.

2. Description of Related Art

Speech recognition or voice recognition systems have begun to gain widened acceptance in a variety of practical applications. In conventional voice recognition systems, a caller interacts with a voice response unit having a voice recognition capability. Such systems typically either request a verbal input or present the user with a menu of choices, and wait for a verbal response, interpret the response using voice recognition techniques, and carry out the requested action, all typically without human intervention.

In order to successfully deploy speech recognition systems for voice-dialing and command/control applications, it is highly desirable to provide a uniform set of features to a user, regardless of whether the user is in their office, in their home, or in a mobile environment (automobile, walkig, etc.). For instance, in a name-dialing application, the user would like a contact list of names accessible to every device the user has that is capable of voice-activated dialing. It is desirable to provide a common set of commands for each device used for communication, in addition to commands that may be specific to a communication device (e.g. a PDA, cellular phone, home/office PC, etc.). Flexibility in modifying vocabulary words and in customizing the vocabulary based upon user preference is also desired.

Current speech recognition systems typically perform recognition at a central server, where significant computing resources may be available. However, there are several reasons for performing speech recognition locally on a client device. Firstly, a client-based speech recognition device allows the user to adapt the recognition hardware/software to the specific speaker characteristics, as well as to the environment. For example, mobile environment versus home/office environment, handset versus hands-free recognition, etc.

Secondly, if the user is in a mobile environment, the speech data does not suffer additional distortions due to the mobile channel. Such distortion can significantly reduce the recognition performance of the system. Furthermore, since no speech data needs to be sent to a server, bandwidth is conserved.

### SUMMARY OF THE INVENTION

The present invention provides a method and system that enables a stored vocabulary to be dynamically updated. The system includes a client device and a server in communication with each other. The client device receives input speech from a suitable input device such as a microphone, and includes a processor that determines the phrase in currently active vocabulary most likely to have been spoken by the user in the input speech utterance.

If the speech is recognized by the processor with a high degree of confidence as one of the phrases in the active vocabulary, appropriate action as determined by a client application, which is run by the processor, may be performed. The client application may dynamically update the active vocabulary for the next input speech utterance. Alternatively, the recognized phrase may be sent to the server and the server may perform some action on behalf of the client device, such as accessing a database for information needed by the client device for example. The server sends the result of this action to the client device and also sends an update request to the client device with a new vocabulary for the next input speech utterance. The new vocabulary may be sent to the client device via a suitable communication path.

The method and system provide flexibility in modifying the active vocabulary “on-the-fly” using local or remote applications. The method is applicable to arrangements such as automatic synchronization of user contact lists between the client device and a web-server. The system additionally provides the ability for the user to customize a set of voice-activated commands to perform common functions, in order to improve speech recognition performance for users who have difficulty being recognized for some of the preset voice-activated commands.

### BRIEF DESCRIPTION OF THE DRAWINGS

The present invention will become more fully understood from the detailed description given hereinbelow and the accompanying drawings, wherein like elements are represented by like reference numerals, which are given by way of illustration only and thus are not limitative of the present invention and wherein:

FIG. 1 illustrates a system according to an embodiment of the present invention; and

FIG. 2 is a flowchart illustrating a method according to an embodiment of the present invention.

### DETAILED DESCRIPTION

As defined herein, the term “input speech utterance” may be any speech that is spoken by a user for the purpose of being recognized by the system. It may represent a single spoken digit, letter, word or phrase or sequence of words and may be delimited by some minimum period of silence. Additionally where used, the phrase “recognition result” is the best interpretation from the currently active vocabulary, of input speech utterance, that has been determined by the system of the present invention.

The terms “speaker” or “user” are synonymous and represent a person who is using the system of the present invention. The phrase “speech templates” is indicative of the parametric models of the speech representing each of the phonemes in a language and is well known in the art. A phoneme is the smallest phonetic unit of sound in a language for example, the sounds “d” and “t”. The speech templates also contain one or more background templates that represent silence segments and non-speech segments of speech, and are used to match corresponding segments in the input speech utterance during the recognition process.

The term “vocabulary” is indicative of the complete collection of commands or phrases understood by the device. Additionally, the term “active vocabulary” where used is indicative of a subset of the vocabulary that can be recognized for the current input speech utterance. The phrase “voice dialog” is indicative of voice interaction of a user with a device of the present invention.

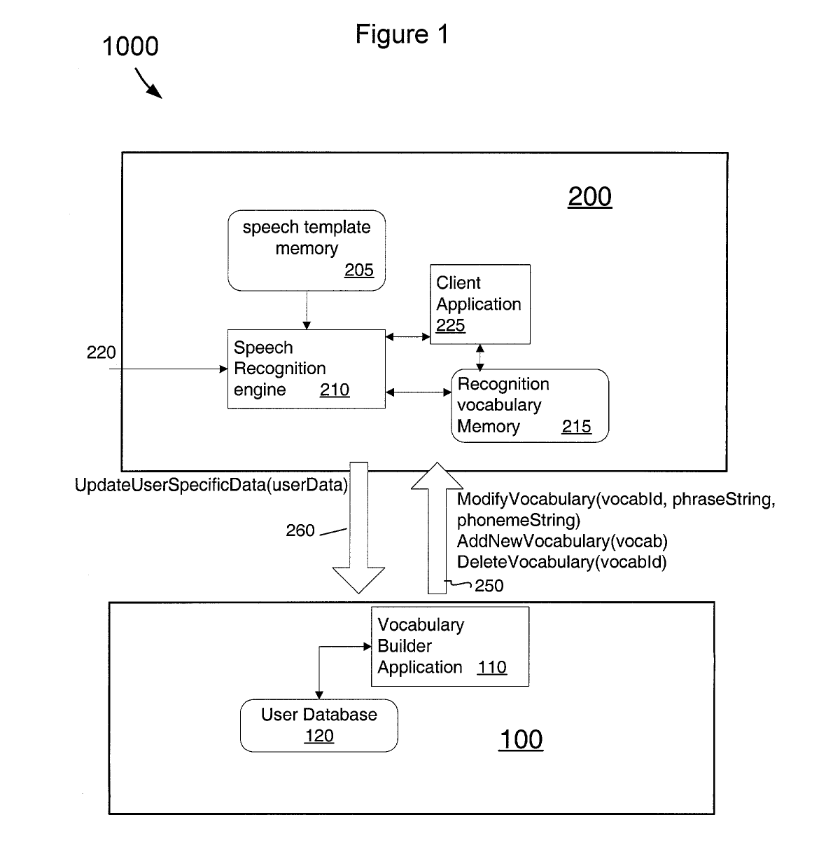

FIG. 1 illustrates an exemplary system 1000 in accordance with the invention. Referring to FIG. 1, there is a system 1000 that includes a server 100 in communication with a client device 200. The server 100 includes a vocabulary builder application 110 and a user database 120. The client device 200 includes a speech template memory 205, a speech recognition engine 210 that receives an input speech utterance 220 from a user of the system 1000, a recognition vocabulary memory 215 and a client application 225.

The system 1000 and/or its components may be implemented through various technologies, for example, by the use of discrete components or through the use of large scale integrated circuitry, applications specific to integrated circuits (ASIC) and/or stored program general purpose or special purpose computers or microprocessors, including a single processor such as a digital signal processor (DSP) for speech recognition engine 210, using any of a variety of computer-readable media. The present invention is not limited to the components pictorially represented in the exemplary FIG. 1, however; as other configurations within the skill of the art may be implemented to perform the functions and/or processing steps of system 1000.

Speech template memory 205 and recognition vocabulary memory 215 may be embodied as FLASH memories as just one example of a suitable memory. The invention is not limited to this specific implementation of a FLASH memory and can include any other known or future developed memory technology. Regardless of the technology selected, the memory may include a buffer space that may be a fixed, or a virtual set of memory locations that buffers or which otherwise temporarily stores speech, text and/or vocabulary data.

The input speech utterance 220 is presented to speech recognition engine 210, which may be any speech recognition engine that is known to the art. The input speech utterance 220 is preferably input from a user of the client device 200 and may be embodied as, for example, a voice command that is input locally at the client device 220, or transmitted remotely by the user to the client device 220 over a suitable communication path. Speech recognition engine 210 extracts only the information in the input speech utterance 220 required for recognition. Feature vectors may represent the input speech utterance data, as is known in the art. The feature vectors are evaluated for determining a recognition result based on inputs from recognition vocabulary memory 215 and speech template memory 205. Preferably, decoder circuitry (not shown) in speech recognition engine 210 determines the presence of speech. At the beginning of speech, the decoder circuitry is reset, and the current and subsequent feature vectors are processed by the decoder circuitry using the recognition vocabulary memory 215 and speech template memory 205.

Speech recognition engine 210 uses speech templates accessed from speech template memory 205 to match the input speech utterance 220 against phrases in the active vocabulary that are stored in the recognition vocabulary memory 215. The speech templates can also be optionally adapted to the speaker's voice characteristics and/or to the environment. In other words, the templates may be tuned to the user's voice, and/or to the environment in which the client device 200 receives the user's speech utterances from (e.g., a remote location) in an effort to improve recognition performance. For example, a background speech template can be formed from the segments of the input speech utterance 220 that are classified as background by the speech recognition engine 210. Similarly, speech templates may be adapted from the segments of input speech utterance that are recognized as individual phonemes.

System 1000 is configured so that the active vocabulary in recognition vocabulary memory 215 can be dynamically modified, (i.e., “on the fly” or in substantially real time), by a command from an application located at and run on the server 100. The vocabulary may also be updated by the client application 225, which is run by the client device 200, based upon a current operational mode that may be preset as a default or determined by the user. Client application 225 is preferably responsible for interaction with the user of the system 100 and specifically the client device 200, and assumes overall control of the voice dialog with the user. The client application 225 also provides the user with the ability to customize the preset vocabulary for performing many common functions on the client device 200, so as to improve recognition performance of these common functions.

The client application 225 uses a speaker-dependent training feature in the speech recognition engine 210 to customize the preset vocabulary, as well as to provide an appropriate user interface. During speaker-dependent training, the system uses input speech utterance to create templates for new speaker-specific phrases such as names in the phone book. These templates are then used for the speaker-trained phrases during the recognition process when the system attempts to determine the best match in the active vocabulary. For applications such as voice-activated web browsing or other applications where the vocabulary may change during the voice-dialog, the server 100 has to change the active vocabulary on the client device 200 in real-time. In this respect, the vocabulary builder application 110 responds to the recognition result sent from the client device 200 to the server 100 and sends new vocabulary to the client device 200 to update the recognition vocabulary memory 215.

On the other hand, client device 200 may need to update the vocabulary that corresponds to the speaker-dependent phrases when a user trains new commands and/or names for dialing. The client application 225 is therefore responsible for updating the vocabulary in the recognition vocabulary memory block 215 based upon the recognition result obtained from recognition engine 210. The updated data on the client device 200 may then be transferred to the server 100 at some point so that the client device 200 and the server 100 are synchronized.

For typical applications, the active vocabulary size is rather small (<50 phrases). Accordingly, due to the smaller vocabulary size, complete active vocabulary may be updated dynamically using a low-bandwidth simultaneous voice and data (SVD) connection, so as not to adversely affect the response time of system 1000. Typically, this is accomplished by inserting data bits into the voice signal at server 100 before transmitting the voice signal to a remote end (not shown) at client device 200, where the data and voice signal are separated.

Referring again to FIG. 1, server 100 includes the above noted vocabulary builder application 110 and user database 120. Server 100 is configured to download data that may also include the input vocabulary representing currently active vocabulary at a relatively low-bit rate, such as 1-2 kbits/s, to the client device 200 via communication path 250. This download may be done by using a SVD connection, in which the data is sent along with speech using a small part of the overall voice bandwidth, and then extracted at the client device 200 without affecting the voice quality. The data may also be transmitted/received using a separate wireless data connection between the client device 200 and the server 100. As discussed above, the client device's 200 primary functions are to perform various recognition tasks. The client device 200 is also configurable to send data back to the server 100, via the communication path 260 shown in FIG. 3.

The vocabulary builder application 110 is an application that runs on the server 100. The vocabulary builder application 110 is responsible for generating the currently active vocabulary into a representation that is acceptable to the speech recognition engine 210. The vocabulary builder application 110 may also send individual vocabulary elements to the client application 225 run by speech recognition engine 210 for augmenting an existing vocabulary, through a communication path 250 such as an SVD connection or a separate wireless data connection to the client device 200.

The user database 120 maintains user-specific information, such as a personal name-dialing directory for example, that can be updated by the client application 225. The user database 120 may contain any type of information about the user, based on the type of service the user may have subscribed to, for example. The user data may also be modified directly on the server 100.

Additionally illustrated in FIG. 1 are some exemplary Application Programming Interface (API) functions used in communication between the client device 200 and server 100, and more specifically between client application 225 and vocabulary builder application 110. These API functions are summarized as follows:

ModifyVocabulary(vocabID, phrasestring, phonemestring). This API function modifies an active vocabulary in the vocabulary memory 215 with the new phrase (phraseString), and the given phoneme sequence (phonemeStrings). The identifier (vocabID) is used to identify which vocabulary should be updated.

AddNewVocabulary(vocab). This API function adds a new vocabulary (vocab) to the recognition vocabulary memory 215, replacing the old or current vocabulary.

DeleteVocabulary(vocabld). This API function deletes the vocabulary that has vocabid as the identifier from the recognition vocabulary memory 215.

UpdateUserSpecificData(userData). This API function updates the user data in the server 100. This could include an updated contact list, or other user information that is gathered at the client device 200 and sent to the server 100. The identifier (userData) refers to any user specific information that needs to be synchronized between the client device 200 and the server 100, such as a user contact list, and user-customized commands.

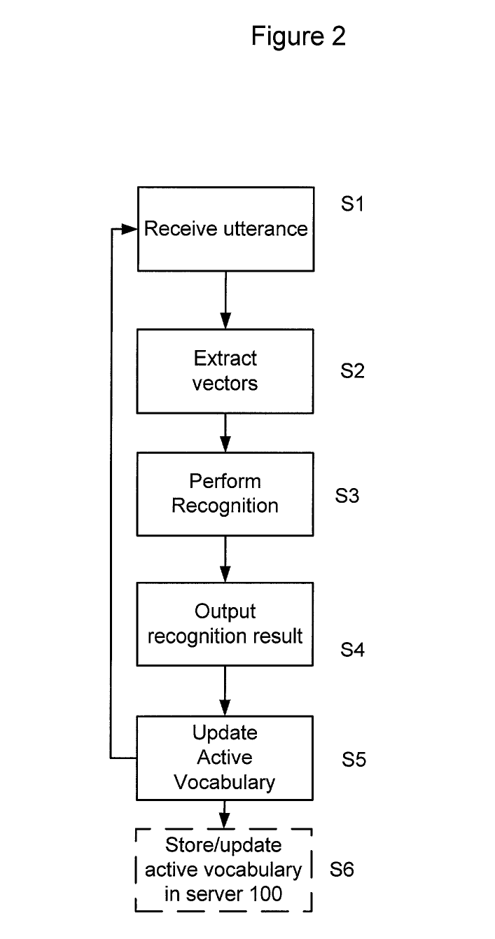

FIG. 2 is a flowchart illustrating a method according to an embodiment of the present invention. Reference is made to components in FIG. 1 where necessary in order to explain the method of FIG. 2.

Initially, a client device 200 receives an input speech utterance 220 (Step S1) as part of a voice dialog with a user. Typically the input speech utterance 220 is input over a suitable user input device such as a microphone. The input speech utterance 220 may be any of spoken digits, words or an utterance from the user as part of a voice dialog.

Speech recognition engine 210 extracts (Step S2) the feature vectors from the input speech utterance 220 necessary for recognition. Speech recognition engine 210 then uses speech templates accessed from speech template memory 205 to determine the most likely active vocabulary phrase representing the input speech utterance 220. Each vocabulary phrase is represented as a sequence of phonemes for which the speech templates are stored in the speech template memory 205. The speech recognition engine 210 determines the phrase for which the corresponding sequence of phonemes has the highest probability by matching (Step S3) the feature vectors with the speech templates corresponding to the phonemes. This technique is known in the art and is therefore not discussed in further detail.

If there is a high probability match, the recognition result is output singly or with other data (Step S4) to server 100 or any other device operatively in communication with client device 200 (i.e., hand held display screen, monitor, etc.). The system 1000 may perform some action based upon the recognition result. If there is no match or even if there is a lower probability match, the client application 225 may request the user to speak again. In either case, the active vocabulary in recognition vocabulary memory 215 on the client device 200 is dynamically updated (Step S5) by the client application 225 run by the speech recognition engine 210. This dynamic updating is based on the comparison that gives the recognition result, or based upon the current state of the user interaction with the device. The dynamic updating may be performed almost simultaneously with outputting the recognition result (i.e., shortly thereafter). The now updated recognition vocabulary memory 215, and system 100, is now ready for the next utterance, as shown in FIG. 2.

The vocabulary may also be updated on the client device 200 from a command sent to the client device 200 from the server 100, via communication path 250. Optionally, the updated active vocabulary, such as the user contact list, and the user-customized commands in recognition vocabulary memory 215 may be sent (Step S6, dotted lines) from client device 200 to server 100 via communication path 260 for storage in user database 120, for example.

### EXAMPLE 1

For example, if the client device 200 is running a web-browsing client application 225, the active vocabulary typically consists of a set of page navigation commands such as “up”, “down” and other phrases that depend upon the current page the user is at during the web-browsing. This part of active vocabulary will typically change as the user navigates from one web-page to the other. The new vocabulary is generated by the server 100 as a new page, is accessed by client device 200 (via the user) and then sent to the client application 225 for updating the recognition vocabulary memory 215. Specifically, the recognition vocabulary memory could be dynamically updated using the AddNewVocabulary (vocabld, vocabularyPhrases, vocabPhrasePhonemes) API function that is implemented by the client application 225 upon receipt from server 100. Alternatively, as an example, if the client application 225 consists of a voice-dialing application in which a user contact list is stored locally on the client device 200, the client application 225 may update the active vocabulary locally under the control of the speech recognition engine 210.

### EXAMPLE 2

The following is an exemplary scenario for running a voicedialing application on the client device 200 in accordance with the invention. The system 1000 may have several voice commands such as “phone book”, “check voice mail”, “record memo” etc. This vocabulary set is initially active. The user input speech utterance 220 is recognized as “phone book”. This results in a currently available contact list to be displayed on a screen of a display device (not shown) that may be operatively connected to client device 200. Alternatively, the names in the list may be generated as voice feedback to the user.

If the list is initially empty, a user-specific name-dialing directory may be downloaded to the client device 200 from server 100 when the user enables a voice-dialing mode. Alternatively, the directory may be initially empty until the user trains new names. At this time, the active vocabulary in recognition vocabulary memory 215 contains default voice commands such as “talk”. “search_name” “next_name”, prev_name“, “add_entry”, etc. The user then may optionally add a new entry to the phone book through a suitable user interface such as a keyboard or keypad, remote control or graphical user interface (GUI) such as a browser. Adding or deleting names alternatively may be done utilizing a speaker-dependent training capability on the client device 200.

The modified list is then transferred back to the server 100 at some point during the interaction between server 100/client device 200, or at the end of the communication session. Thus, the name-dialing application enables the user to retrieve an updated user-specific name-dialing directory the next time it is accessed. If the user speaks the phrase “talk” then the active vocabulary changes to the list of names in the phone book and the user is prompted to speak a name from the phone book. If the recognized phrase is one of the names in the phone book with high confidence, the system dials the number for the user. At this point in the voice-dialog, the active vocabulary may change to “hang up”, “cancel”. Accordingly, the user can thereby make a voice-activated call to someone on his/her list of contacts.

### EXAMPLE 3

As an example of vocabulary customization, the system 1000 may have difficulty in recognizing one or more command words from a user due to specific accent and other user-specific speech features. A speaker-dependent training feature in the client device 200 (preferably run by speech recognition engine 210) is used to allow a user to substitute a different, user-selected and trained, command word for one of the preset command words. For example, the user may train the word “stop” to replace the system-provided “hang up” phrase to improve his/her ability to use the system 1000.

The system 1000 of the present invention offers several advantages and can be used for a variety of applications. The system 1000 is applicable to hand-held devices that allow voice dialing. The ability to dynamically change the current active vocabulary and to add/delete new vocabulary elements in real time provides a more powerful hand-held device. Additionally, any application that makes use of voice recognition, which runs on the server 100 and which requires navigation through multiple menus/pages and will benefit from the system 1000 of the present invention.

The flexible vocabulary modification available in the system 1000 allows any upgrade to the voice recognition features on the client device 200 without requiring an equipment change, thereby extending the life of any product using the system. Further, the system 1000 enables mapping of common device functions to any user-selected command set. The mapping feature allows a user to select vocabulary that may result in improved recognition.

Although the exemplary system 1000 has been described where the client device 200 and server 100 are embodied as or provided on separate machines, client device 200 and server 100 could also be running on the same processor. Furthermore, the data connections shown as paths 250 and 260 between the client device 200 and server 100 may be embodied as any of wireless channels, ISDN, or PPP dial-up connections, in addition to SVD and wireless data connections.

The invention being thus described, it will be obvious that the same may be varied in many ways. For example, the functional blocks in FIG. 1 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of external supplied propagated signal(s). Such variations are not to be regarded as departure from the spirit and scope of the invention, and all such modifications as would be obvious to one skilled in the art are intended to be included within the scope of the following claims.

What is claimed is:

1. A method of recognizing speech so as to modify a currently active vocabulary, comprising:
receiving an utterance;
comparing said received utterance to a stored recognition vocabulary representing a currently active vocabulary; and
dynamically updating the stored recognition vocabulary for subsequent received utterances based on said comparison.

2. The method of claim 1, the received utterance being received in a voice dialog from a user, the step of dynamically updating the stored recognition vocabulary being based on a current state of user interaction in the voice dialog and on a recognition result.

3. The method of claim 1, said step of dynamically updating the recognition vocabulary including running an application to update the stored recognition vocabulary.

4. The method of claim 3, said application being an application run by a client device, or being an application run by a server in communication with the client device.

5. The method of claim 4, wherein said application is a web-based application having multiple pages, said stored recognition vocabulary being dynamically updated as a user navigates between different pages.

6. The method of claim 1, said step of receiving including extracting only information in said received utterance necessary for recognition.

7. The method of claim 1, said step of comparing including comparing a speech template representing said received utterance to said stored recognition vocabulary.

8. A speech recognition system, comprising:
a client device receiving an utterance from a user; and
a server in communication with the client device, the client device comparing the received utterance to a stored recognition vocabulary representing a currently active vocabulary, recognizing the received utterance and dynamically updating the stored recognition vocabulary for subsequent received utterances.

9. The system of claim 8, wherein the dynamically updating of the stored recognition vocabulary is dependent on a current state of user interaction in the voice dialog and on a recognition result from the comparison.

10. The system of claim 8, the client device further including an application that dynamically updates the stored recognition vocabulary.

11. The system of claim 8, the server further including a vocabulary builder application which dynamically updates the stored recognition vocabulary by sending data to the client application.

12. The system of claim 11, said vocabulary builder application sending individual vocabulary elements to the client device for augmenting the currently active vocabulary.

13. The system of claim 8, the server further including a database storing client-specific data that is updatable by the client device.

14. The system of claim 8, the client device further including a processor for comparing a speech template representing said received utterance to said stored recognition vocabulary to obtain a recognition result, wherein the processor controls the client application to update the stored recognition vocabulary.

15. The system of claim 14, said processor being a microprocessor-driven speech recognition engine.

16. The system of claim 8, wherein the update to the stored recognition vocabulary is stored on the client device and on the server.

17. The system of claim 10, wherein if the application is run on the server, the recognition vocabulary update is sent from server to client device via a communication path.

18. The system of claim 17, said communication path being embodied as any one of a simultaneous voice data (SVD) connection, wireless data connection, wireless channels, ISDN connections, or PPP dial-up connections.

19. A method of customizing a recognition vocabulary on a device having a current vocabulary of preset voice-activated commands, comprising:
receiving an utterance from a user that is designated to replace at least one of the preset voice-activated commands in the stored recognition memory; and
dynamically updating the recognition vocabulary with the received utterance.

20. The method of claim 19, the user implementing a speaker-training feature on the device in order to dynamically update the recognition vocabulary.

21. The method of claim 19, wherein the received utterance replaces a voice-activated command that is difficult for the device to recognize when input by the user, so as to enhance the usability of the device.
